(19) United States
(12) Patent Application Publication
(10) Pub. No.: US 2012/0014749 A1
(43) Pub. Date: Jan. 19, 2012

(54) REMEDIATION OF POLLUTED MATERIALS OR SITES

(75) Inventor: Jo Bonroy, Gent (BE)

(73) Assignee: Universiteit Gent, Gent (BE)

(21) Appl. No.: 13/257,123

(22) PCT Filed: Mar. 19, 2010
(86) PCT No.: PCT/EP10/53593

§ 371 Date: Sep. 16, 2011

(30) Foreign Application Priority Data
Mar. 19, 2009 (GB) 0904710.1

(51) Int. Cl. A62D 3/00; G06F 17/10; C02F 3/34

(52) U.S. Cl. 405/128.45; 435/262; 703/2

(57) ABSTRACT

The invention relates to a method and a system for controlling a remediation of a site polluted by contaminants, the method comprising the steps of determining a concentration gradient of gaseous emissions exhausting from the polluted site taking into account the measured indications measured at a plurality of spatially distinct positions, and controlling a remediation technique taking into account the concentration gradient. Automatic feedback for controlling the underlying remediation technique is thus enabled taking into account the concentration gradient.

### FIELD OF THE INVENTION

The invention relates to a method and a system for controlling a remediation of materials or sites polluted by contaminants, e.g. including ex situ methods that use bio-remediation.

### BACKGROUND OF THE INVENTION

Generally, a so-called environmental remediation deals with the removal of pollution or contaminants from environmental media, such as air, soil, groundwater, sediment, or surface water, for a general protection of human health and the environment. Remediation is often subject to an array of regulatory requirements, and can also be based on assessment of human health and ecological risks where no legislated standard exist or where standards are advisory.

The remediation of contaminated soils has become more and more important in recent years with the advent of more stringent environmental laws. A particular problem is the contamination with petroleum products such as gasoline, diesel fuel, and heating oil, for example due to leakage from underground storage tanks. Further, due to stricter regulations, the remediation of such contaminated sites has become a rapidly growing industry.

Many different remediation techniques are known from the prior art that can be categorized into ex-situ and in-situ methods. Ex-situ methods involve excavation of impacted soils and subsequent treatment at a surface, in-situ methods seek to treat the contamination without removing the soil. Ex situ processes can be as simple as hauling the contaminated soil to a regulated landfill, but can also involve aerating the excavated material in the case of volatile organic compounds (VOCs). Newer in-situ oxidation techniques have become popular for the remediation of a wide range of soil and groundwater contaminants. Remediation by chemical oxidation involves the injection of strong oxidants such as hydrogen peroxide, ozone gas, potassium permanganate or persulfates. Another effective remediation technique for soil is soil vapour extraction (SVE). Soil vapour extraction is a physical means of removing or reducing concentrations of volatile organic compounds that partition into a vapour phase.

The treatment of environmental problems through biological means is known as bio-remediation. Bio-remediation is the use of living organism for detoxification of contaminated materials or sites. It can involve either the introduction of specific organisms and/or the stimulation of indigenous bacteria. The technique can be used to degrade a wide variety of organic compounds present at various levels in contaminated soils. One of the most important advantages of biological degradation over conventional techniques is the fact that the contaminants are usually broken down to harmless substances whereas conventional techniques usually only temporarily displace the problem or transfer the contaminants to another medium. As an example of a new technique, EP 1 446 240 describes a process for the remediation of polluted sites which comprises a series of sensors for monitoring the progress of the bio-remediation and for controlling the availability of oxygen and humidity, wherein the flow rate of the process fluids and the operating time of the equipment is regulated based on the data received from the sensors. However, regulatory instances are highly concerned with the amount of emissions from the remediation technique towards the atmosphere. The process described in EP 1 446 240 and other remediation processes known from the prior art do not provide a possibility for controlling the utilized remediation technique for not exceeding regulatory emission limits.

### SUMMARY OF THE INVENTION

It is the object of the invention to provide a possibility for controlling the emissions towards the atmosphere of a remediation technique. The present invention can control the emissions towards the atmosphere of a remediation technique in such a manner that regulatory limits are not exceeded. Bio-remediation is the use of living organism for detoxification of contaminated materials or sites, e.g. including ex situ methods that use bio-remediation.

It is an advantage of at least some embodiments of the present invention that pro-active control of the remediation technique can be obtained, whereby the remediation speed can be maximised without exceeding regulatory limits on emission and/or horizontal distribution. The latter may be based on predictive modelling.

This object is addressed by a method for controlling a remediation of a material or site polluted by contaminants, the method comprising the steps of obtaining at a plurality of spatially distinct positions a measured indication of a level of the contaminants, e.g. a concentration of the contaminants, in the atmosphere above the material or ground of the site and/or in the material or in the soil air of the site, calculating, e.g. leading to the calculation, of a concentration gradient of gaseous contaminants exhausting from the polluted material or site taking into account the measured indications measured at a plurality of spatially distinct positions, and controlling a remediation technique taking into account the concentration gradient or the gaseous contaminants exhausting from the polluted material or site. The concentration gradient may be a spatial concentration gradient.

Accordingly, it is an essential idea of embodiments of the invention to determine the concentration gradient of the gaseous contaminant or volatilised contaminant from the polluted material or site, and based on the concentration gradient, to control the remediation technique for the remediation of the polluted material or site. This is advantageous over the prior art, since the invention enables an automatic feedback for controlling the underlying remediation technique taking into account the concentration gradient. A further advantage is, that the remediation of the polluted material or site can be controlled precisely, since the magnitude of the concentration gradient determines how fast the gaseous emissions exhausting from the polluted material or site increase or how slowly the gaseous emissions exhausting from the polluted material or site decrease. This allows further for a faster or even pro-active controlling of the remediation technique resulting in a better remediation of the polluted material or site for avoiding undesired gaseous emissions.

The present invention includes applications in venting and sparging as well. The proposed method can be used in combination with bioventing and biosparging. Soil venting and air-sparging are generally combined with a SVE unit to enable the collection of the gaseous contaminants for off-gas treatment. A soil venting or bioventing can also be implemented by means of a SVE unit purging the polluted soil mass with atmospheric air pulled in through the soil surface and collected in the vacuum well. An advantage of embodiments of the present invention is that they are designed to avoid the need for SVE if needed for the off-gas treatment and the off-gas treatment itself during bioremediation.

Calculating a concentration gradient of gaseous contaminants may comprise in some embodiments determining a concentration gradient of gaseous contaminants exhausting from the polluted material or site based on a remediation model using the plurality of spatially distinct measured indications of a level of the contaminants, e.g. the concentrations. The use of a remediation model may allow to take into account the different processes occurring during the remediation.

The step of controlling the remediation technique may in some embodiments also comprise determining a future concentration gradient of the gaseous contaminants using a predictive remediation model. The calculated concentration gradient at the moment it is observed is compared with the predicted concentration gradient. In case of a deviation beyond a preset threshold value the operational parameters of the remediation technique are to be adapted.

According to another preferred embodiment of the invention, the method comprises the step of measuring the gaseous contaminants in a buffer zone overlying the polluted material or site. This buffer zone might be an unpolluted soil layer lying above the contaminated soil mass or might have been applied specifically. The buffer zone can be the soil above the polluted zone. It may have a texture ranging for example from a sandy soil to a clay-loam soil and/or peat. The buffer zone may comprise any layer next to the polluted zone capable of providing a degradation or absorption capacity or exceeding the volatilization of contaminants from within the buffer zone itself. In this way, the buffer zone thus may comprise in some embodiments the polluted soil medium. When applying a material as buffer as can be done in biopiles, a peat buffer is a good choice, e.g. peat can provide enough surface area and a good environment to detoxify VOC from the underlying biopile, not only absorb them. Hence, the present invention includes not only absorbing gas contaminants but also degrading, e.g. detoxifying them. Other types of material are applicable as well for the buffer layer.

In general, the gaseous emissions can be measured by any kind of measuring means. However, according to a preferred embodiment of the invention, the gaseous emissions are measured by a plurality of gas sensors, which are offset in a vertical extent in a buffer zone overlying the polluted material or site. Although gas specific sensors might be selected in case of a single contaminant of interest, other examples also can be used such as for example volatile organic compound (VOC) gas sensors. It is further preferred, that the gas sensors are selected based on the type of the pollution and the toxicity of all involved compounds. It is also possible to use less specific gas sensors each of which can respond to a wider range of compounds, however, a broader sensitivity of the gas sensors can reduce the accuracy of the measurement. On the other hand it offers an advantage that unexpected intermediate products will be detected as well thus preventing a risk of emitting undesirable levels of possibly toxic intermediate products. In terms of the vertical extent, it is preferred that the most upper gas sensor is installed near the upper end of the buffer zone, if present, and/or that further gas sensors are installed in the vertical extent below the most upper gas sensor. It is further preferred that the lowest gas sensor is installed near the lower end of the buffer zone or already in the polluted zone. It is to be noticed that in some cases of low contamination, the system may be operated without buffer zone. The sensors then may be provided in the polluted zone.

According to another preferred embodiment of the invention, the step of controlling the remediation technique comprises checking that the gaseous emissions are not exceeding a predefined level. Such a predefined level can be provided for example by a regulatory instance or by a government, wherein the predefined level may differ according to the type of pollution exhausting from the polluted material or site. Checking the gaseous emissions not exceeding a predefined level is advantageous, since such a feature can guarantee compliance with government regulations and may secure, that the remediation does not violate regulatory requirements.

According to another preferred embodiment of the invention, the step of controlling the remediation technique comprises calculating a remediation model according to the concentration gradient. Additional variables can be used in the model, e.g. diffusivity, soil air flux, . . . and other variables readily used within soil remediation projects. The remediation model may be calculated in such a way, that the gaseous emissions do not exceed the predefined level by taking care of the concentration gradient measured by the plurality of gas sensors. Further, the remediation model can be calculated based on parameters of the buffer zone and/or the type of contaminants. In this way, using the remediation model can further optimize the remediation of a polluted site in terms of efficiency, which means reducing costs and duration for the remediation of the polluted site. The present invention has the advantage of being able to reduce the costs compared to a bioremediation including an SVE to prevent unacceptable emission levels. The costs for the inclusion of the SVE can be high.

The step of controlling the remediation technique may comprise, based on the determined future concentration gradient, the step of increasing remediation without exceeding a predefined level.

While the remediation model can be based on any optimization algorithm known from prior art, it is according to another preferred embodiment of the invention preferred, that the remediation model is adapted for determining, e.g. determines, the maximum degradation of the polluted zone without exceeding the remediation capacity of the buffer zone. This means that the buffer zone can provide a degradation rate which is larger than required to remediate the gaseous emissions exhausting from the polluted zone towards the buffer zone and gaseous contaminants originating from within the buffer zone itself. In other words, the invention provides a method for obtaining the maximum degradation of the polluted site without exceeding the remediation capacity of the buffer zone and without exceeding a predefined level for the gaseous emissions, such as defined for example by a regulatory instance of a government.

The remediation technique may comprise extraction of the gaseous contaminants using a soil vapour extraction and off-gas treatment system, wherein the soil vapour extraction and/or off-gas treatment system is controlled taking into account the determined future concentration gradient.

In some embodiment the predictive remediation model may be adapted for determining the maximum degradation of the polluted site without exceeding the remediation capacity of the polluted zone, the polluted soil medium and the buffer zone combined, or if the polluted soil medium is considered part of the buffer zone, without exceeding the remediation capacity of the combined polluted zone and buffer zone.

According to another preferred embodiment of the invention, the step of controlling the remediation technique comprises using a self-learning optimisation model. During a learning process of the self-learning optimisation model, the remediation speed can be gradually increased until further enhancement would cause unacceptable gaseous emissions, for example exceeding the predefined levels. Once the learning process has finished, the remediation technique can be controlled by the self-learning optimisation model in such a way that during each moment the maximum remediation speed can be obtained in the buffer zone and in the polluted zone without exceeding the permitted emission levels. Using such a self-learning optimisation model is advantageous, since it further improves the efficiency of the remediation in terms of decreasing costs and decreasing the duration of the remediation of the polluted site to the minimum without exceeding the preset emission levels without having to resort to off-gas treatment.

According to a further preferred embodiment of the invention, the remediation technique comprises a treatment in-situ, such as bio-sparging and/or bio-venting, and/or the treatment ex-situ, such as bio-piles and/or land farming. This means that the invention is applicable to a wide area of remediation techniques, while limiting the gaseous emissions to predefined levels and obtaining an optimal remediation of the polluted site.

The concentration gradient may be a spatial concentration gradient.

The object of the invention is further addressed by a system for controlling a remediation of a material or site polluted by contaminants, the system comprising a control unit for calculating a concentration gradient, e.g. spatial concentration gradient, of gaseous contaminants exhausting from the polluted material or site towards the atmosphere based on obtained measured indications of a level of the contaminants obtained at a plurality of spatially distinct positions in the atmosphere above the material or ground of the site and/or in the material and/or in the soil air of the site and for controlling a remediation technique taking into account the calculated concentration gradient of, the gaseous contaminants exhausting from the polluted material or site. Such a system, although not being limited thereto, may encompass a system comprising a buffer zone overlying the polluted material or site and a control unit for determining a concentration gradient of gaseous emissions of the polluted material or site in a vertical extent of the buffer zone and for controlling a remediation technique according to the concentration gradient. In this way, the remediation of a site polluted by contaminants can be controlled by the control unit according to the concentration gradient of gaseous emissions exhausting from the polluted material or site into the buffer zone. This means, as the concentration gradient is used for controlling the remediation technique, that the magnitude of the concentration gradient and its position within the buffer zone determines the extent of the actual emissions while the rate of change of the concentration gradient determines how fast the gaseous emission of the polluted material or site increase or decrease. In this way, the remediation of a material or site polluted by contaminants can be controlled very precisely.

In some embodiments, the control unit may be adapted for determining a concentration gradient of gaseous contaminants exhausting from the polluted material or site based on a remediation model using said plurality of spatially distinct measured indications.

In some embodiments, the control unit is adapted for determining a future concentration gradient using a predictive remediation model, for comparing the determined future concentration gradient with the calculated concentration gradient and for deciding based thereon if the remediation technique is to be adapted.

According to another preferred embodiment of the invention, the system further comprises a plurality of gas sensors installed in a vertical extent of the buffer zone for measuring or calculating the concentration level of the volatilised contaminants in the gas phase. Preferably, the gas sensors are provided as volatile organic compound (VOC) sensors. It is further preferred, that a plurality, i.e. at least two gas sensors are installed in the vertical extent of the buffer zone.

While the control unit can use any algorithm or model for controlling the remediation technique, it is according to another preferred embodiment of the invention preferred, that the control unit is adapted for controlling the remediation technique towards achieving the maximum degradation of the polluted site being defined without exceeding the remediation capacity of the buffer zone by more gaseous emissions than are allowed to be emitted towards the atmosphere. This means, that the system according to the invention avoids gaseous emissions exhausting into the atmosphere in excess of the permitted emission levels, as the control unit controls the remediation technique preventing a gaseous contaminant flux from the polluted zone towards the buffer zone augmenting the gaseous emissions originating from within the buffer zone to exceed the remediation capacity of the buffer zone by more than the permitted emission levels towards the atmosphere. This means further, that the buffer zone determines the maximum degradation capacity of the system which is used for the remediation of the polluted site.

According to another preferred embodiment of the invention, the system further comprises a polluted zone producing gaseous emissions and a polluted soil medium for transferring the gaseous emissions towards the buffer zone, wherein the polluted soil medium is positioned between the polluted zone and the buffer zone and primarily acts for transferring the contaminants from the polluted zone towards the buffer zone. It is further preferred that the polluted zone and/or the polluted soil medium comprises sandy soil, clay-loam soil, peat or any other comparable soil medium. There need not be directly treated polluted soil mass between the polluted zone under treatment and the buffer zone. If that is the case, the technique can operate well for polluted soil classes which fall within the range of textures. Peat or any other comparable (soil) medium can be mentioned to physically create a buffer zone. The polluted soil medium allows the possibility that only the lowest part of the polluted zone will be treated and that the gaseous emissions are allowed to pass to the buffer zone through a less polluted zone that does not (yet) get remedial attention. Alternatively this could be formulated by the polluted zone being not homogeneously contributing in the supply of contaminants to the buffer zone.

According to another preferred embodiment of the invention, the buffer zone comprises a degradation rate which is sufficient for the remediation of the gaseous emissions. This means that the gaseous emissions of the polluted site can be completely or substantially completely remediated within the buffer zone.

In one aspect, the present invention also relates to a computer program product for, when executing on a computer, performing a method of controlling remediation as described above. The invention also relates to a data carrier comprising such a computer program product and/or the transmission of such a computer program product over a local area network or a wide area network.

While the invention is applicable to a vast variety of polluted sites, it is especially preferred that the polluted site is provided as a biopile, wherein the buffer zone is provided as a reactive barrier capable of absorbing, and/or degrading or detoxifying, and/or remediating the gaseous emissions of the biopile. Such a biopile may consist of an irrigation system to provide sufficient moisture levels to the polluted soil mass and/or an aeration system providing an adequate oxygen supply for the remediation and to provide oxygen to microbes, an irrigation/nutrient injection system to provide nutrients and moisture after biopile construction, and a leachate collection system for controlling excess moisture in the biopile.

These and other aspects of the invention will be apparent from and elucidated with reference to the embodiment described hereinafter.

### BRIEF DESCRIPTION OF THE DRAWINGS

The drawings are only schematic and are non-limiting. In the drawings, the size of some of the elements may be exaggerated and not drawn on scale for illustrative purposes.

FIG. 1 schematically shows a system for controlling a remediation of a site polluted by contaminants according to a preferred embodiment of the invention.

FIG. 2A and FIG. 2B schematically show flow charts of exemplary methods for controlling remediation, according to an embodiment of the present invention.

FIG. 3 illustrates a schematic overview of the column design and of the positioning of the sensors therein for one particular soil venting experiment according to an embodiment of the present invention.

TABLE 1 illustrates characteristics of the repacked soil column as used in the soil venting experiment according to an embodiment of the present invention.

TABLE 2 illustrates characteristics of decane flowing through the column, as used in the soil venting experiment according to an embodiment of the present invention.

FIG. 4 illustrates the evolution of the measured decane concentration at different depths below the surface of the sandy soil column, as obtained in the soil venting according to an embodiment of the present invention.

FIG. 5 illustrates a comparison of the calculated decane mass passing the consecutive sensors, as obtained in the soil venting according to an embodiment of the present invention.

FIG. 6 shows the observed decane concentration measured in the soil venting experiment according to an embodiment of the present invention and the linear extrapolation used to improve the predictive power of the model during a fast concentration change detected by the lowest sensor.

FIG. 7 illustrates the predictive model estimates for the evolution of the decane concentration at different depths based on the measured concentration data available after 2.34 hours as can be used in an embodiment of the present invention.

FIG. 8 illustrates schematic overview of the column design and of the positioning of the sensors therein for a bioventing experiment according to an embodiment of the present invention.

TABLE 3 illustrates characteristics of the repacked soil column as used in the ethanol bioventing experiment according to an embodiment of the present invention.

TABLE 4 illustrates characteristics of ethanol flowing through the column, as used in the ethanol bioventing experiment according to an embodiment of the present invention.

FIG. 9 illustrates the evolution of the measured ethanol concentration at different depths below the surface of the sandy soil column, as obtained in the ethanol bioventing according to an embodiment of the present invention.

FIG. 10 illustrates the evolution of the correlation of determination of an inverse model during gradual expansion of a dataset for the ethanol bioventing experiment according to an embodiment of the present invention.

FIG. 11 illustrates model estimates as compared to the observed evolution of ethanol concentration at different heights in the column during venting with ethanol enriched air, as can be obtained using an embodiment of the present invention.

FIG. 12 illustrates the deviation in time between model and observed data as was obtained in the bioventing experiment, according to an embodiment of the present invention.

FIG. 13 illustrates a computer device for performing a method according to an embodiment of the present invention.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

In the following detailed description of the preferred embodiments, reference is made to the accompanying drawings, which form a part hereof, and within which are shown by way of illustration specific embodiments by which the invention may be practiced. The drawings described are only schematic and are non-limiting. In the drawings, the size of some of the elements may be exaggerated and not drawn on scale for illustrative purposes. Those skilled in the art will recognize that other embodiments may be utilized and structural changes may be made without departing from the scope of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Where in embodiments of the present invention reference is made to an indication of a level of the contaminants reference may be made for example to a concentration of contaminants, to a chemical activity of the contaminant describing an effective concentration of a species of a contaminant in a mixture, etc. The concentration can then be expressed for example as resident concentration in the gas phase, liquid phase or solid phase of the polluted medium separately or can be expressed in the form of a total resident concentration of the three phases combined. It is also possible to define the concentration as the flux-averaged concentration which is commonly used during leaching column tests. In each case, the concentration can be expressed in the form of a mass or volume of the contaminant per volume or mass of the phase or phases. Typical measurements will express the concentration in (ppm or ppb) based on the volumetric gaseous fraction in the gas phase of the polluted medium, (μg·l⁻¹) indicating the mass of the concentration per liter of liquid or gas phase, or (mg·kg⁻²) meaning mg contaminant per kg dry soil. When measuring devices are capable of measuring a wider range of volatile organic components, the indication of a level of the contaminants can be given as an equivalent concentration in function of a calibration of the equipment for a specific standard gas. The proposed method is also capable to utilize this kind of indication of a level of the contaminants. If a composition of the contaminants is known, a correction factor might be used to deduct from this equivalent concentration the concentration of individual components in the gas phase. Using this correction factor might improve the performance of the system, but is not essential. The method will provide adequate results even when using it with semi-quantitative indications of the level of the contaminants. These semi-quantitative input data might occur when the composition of the gas phase is not known definitely or less sensitive measuring devices are used.

A concentration gradient can be defined as the change in concentration of a gaseous contaminant versus time at the same place but can in addition or alternatively also be defined as the change in concentration of a gaseous contaminant versus a spatial dimension at a certain time, the latter also being referred to as spatial concentration gradient. The concentration gradient also may refer to a concentration profile, determined, e.g. by fitting, based on a discrete number of concentration measurements as a function of time and/or space.

Where in embodiments of the present invention reference is made to contaminants, reference may be made to contaminants in the polluted zone or buffer zone, contaminants, e.g. gaseous contaminants, formed thereby or formed as intermediate or end products during remediation. During a remediation the composition of the contaminants may change. New contaminants might be formed, or contaminants might be remediated at different rates leading to changes in the relative fractions of the contaminants in the gas phase. In function of the distance from a polluted zone, the composition of the contaminants might differ as well. For example due to a more selective biodegradation or a difference in effective diffusivity through the soil. Based on site specific conditions certain contaminants might be produced as intermediate products according to a specific spatial pattern. The occurrence of a specific gaseous contaminant and/or its fractions within the overall gas phase can change. The presented method is capable of incorporating these changes by adapting the model utilized for the specific conditions. Although for the presented embodiments the measured concentration gradients are defined based on a single contaminant without changing the composition, the measurement of the indication of the level of the contaminant might be the measurement of a indication of a level of the combined volatile contaminants whether or not considering the changing composition in time or space. A polluted medium as defined for embodiments of this invention is assumed to contain at least a gas phase and a solid phase. The gas phase contains the gaseous contaminants in as far as these are not dissolved in the liquid phase or absorbed onto the solid phase. The water vapor if present in the polluted medium is also included in the gas phase. When the polluted medium is a soil, the terms soil gas or soil air are used as synonyms to the gas phase.

In general a liquid phase will be present as well as is mostly the case when applying the remediation technique to soils. In general, the liquid phase is determined by the moisture in the medium including the dissolved substances. When contaminants are present in the polluted medium in excess of the solubility, a non-aqueous phase can be included. Depending on the choice of the model en the specific site characteristics, this non-aqueous liquid phase has to be viewed separately from the liquid phase which is in that case restricted to the watery liquids with its dissolved substances.

The solid phase is any phase that can be considered immobile and forms at least temporary a matrix. In extreme cases, the liquid and the solid phase may be combined to a virtual, single phase while applying this method.

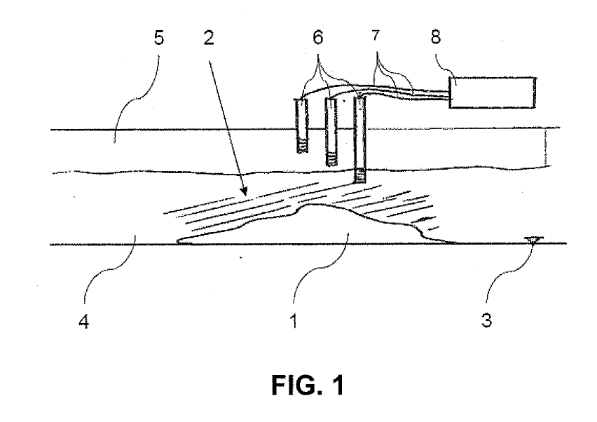

The present invention relates to a system and method for controlling remediation of a site polluted by contaminants. The method comprises the steps of obtaining at a plurality of spatially distinct positions a measured concentration of the contaminants in the atmosphere above the material or ground of the site and/or the concentration of the contaminants in the material or in the soil air of the site. Based on these obtained measured concentrations, a concentration gradient of gaseous contaminants exhausting from the polluted material or site is determined. The remediation technique then is controlled taking into account the concentration gradient of gaseous contaminants exhausting from the polluted material or site. A corresponding system wherein the calculation and the control is performed using a controller is also envisaged. By way of illustration, embodiments of the present invention not being limited thereto, a system for controlling remediation will be further discussed with reference to FIG. 1 illustrating a system for controlling remediation of a site polluted by contaminants according to a preferred embodiment of the invention. The system comprises a polluted zone 1 producing volatile gaseous emissions 2 of pollutants during application of a remediation technique, such as (bio-)sparging, (bio)venting, (bio-)piles and/or land farming. The polluted zone 1 may extend below the groundwater table 3. However, according to the preferred embodiment of the invention, the polluted zone 1 is provided on top of the groundwater table 3.

As it can be seen further from FIG. 1, a polluted soil medium 4 can be provided on top of the polluted zone 1. During application of the remediation technique, the volatile gaseous emissions 2 are transferred from the polluted zone 1 through the polluted soil medium 4 towards a buffer zone 5. The buffer zone 5 can be provided for example as a soil layer, as sandy or clay-loam soil. This includes that the buffer zone is just a non-part or marginally polluted part of the existing soil on the site lying on top of the polluted soil mass.

The system may comprise an input port for receiving measured concentrations or alternatively may comprise a sensor system for providing a plurality of measured concentrations at spatially distinct positions. Such a sensor system may comprise a plurality of sensors or may comprise a displaceable sensor. In the embodiment shown in FIG. 1 the sensor system comprises, by way of example, three gas sensors. Preferably, the first gas sensor 6 is provided near the upper end of the buffer zone 5, the second gas sensor 6 is provided within the buffer zone 5 and the third gas sensor 6 is provided near the lower end of the buffer zone 5. The three gas sensors 6, which are installed in such a vertical extent as shown in FIG. 1, are connected by means of a communication connection that could be cables 7 to a control unit 8, or could be another sort of communication connection such as IR, wireless, optical fibre etc.

The sensor system advantageously is adapted to provide quantitative or semi quantitative measurements of the concentration of one or more volatile organic compounds (VOC's). Most of the usable, available sensors provide a range of molecules that can be being detected. A theoretical link exists between the concentration of the VOC in the gas, water and solid phase. Any sensor that can detect VOC concentrations in one or more of the phases could be used to provide the necessary data. It is, however, preferred to measure the concentration in the gas phase of the soil. Both active and passive sampling devices can be used in most cases as long as the data is available before a correction of the remediation process is required. For slow remediation projects manual readings might be sufficient, but mostly an automated system will be required. The photoionisation detectors that are currently available on the market are active sampling devices that can be used for automated feedback according to our method. Another type of sensors that may be used are chemiresistors.

When applying the remediation technique, gaseous emissions 2 exhaust from the polluted zone 1. The gaseous emissions 2 are transferred further through the soil medium 4 towards the buffer zone 5 for degradation. The gas sensors 6 installed in the vertical extent in the buffer zone 5 measure the concentration of the gaseous emissions 2. A concentration gradient of the gaseous emissions 2 is determined in the control unit 8. The concentration gradient typically may be a spatial concentration gradient. Taking into account this concentration gradient, the remediation technique is controlled by the control unit 8.

Further, the control unit 8 may calculate a predicted concentration gradient using a remediation model taking into account the concentration gradient for controlling the remediation technique, wherein the remediation model may be adapted for defining the maximum degradation of polluted site without exceeding the remediation capacity of the buffer zone 5. The control unit 8 may further utilize a self-learning optimisation model. The latter may for example be based on neural networks.

The control unit 8 may be connected to or comprise a processor for processing the information, e.g. applying the remediation model, calculation concentration gradients, predicting concentration gradients, etc. Based on the obtained result, the control unit is adapted for controlling the remediation technique. The latter may be by providing an output indicating how the remediation parameters should be adapted, or the controller may be connected to control valves for adjusting the remediation parameters.

All crucial parameters involving the successful operation of a bioremediation process can be steered using the feedback from the method. This includes raising the temperature for better performance of microbiological degradation, changing the kind or the amount of nutrients for the microbial degradation of the contaminants, altering the amount of provided carbon source in case co-metabolism is the main degradation path or adapting the injection rate of biosurfactants used to increase the bioavailability of the contaminants. Controlling the moisture level can be a crucial parameter which can be altered relatively easily in biopiles. When the remediation capacity of the buffer zone is underutilized raising the temperature of the injected gas can increase the contaminant inflow in the buffer zone. The temperature can also be increased by electroreclamation causing an increased volatilisation of the contaminants.

Considering that the remediation rate of the system depends on the full exploitation of the remedial capacity in the polluted zone en the buffer zone combined without exceeding the permitted emission levels, all the mentioned adaptations can be provided in the buffer zone or the polluted zone independently providing an optimal combined effect.

In this way, the remediation of the polluted zone 1 can be controlled in such a manner that the gaseous emissions 2 exhausting from the buffer zone 5 into the atmosphere fall within predefined levels, such as defined by a regulatory instance or a government.

In case emissions of the contaminants will be caused mainly due to the advective flux as can happen after the injection of gases in the contaminated soil volume during bioventing, the measurement of the concentration near the surface or the upper end of the buffer zone multiplied with the soil air flux can be used to prove that regulatory emission requirements or requirements based on the assessment of human health and ecological risks are met.

In case emissions of the contaminants are caused mainly due to a diffusive flux as can happen during the monitoring of a natural attenuation or a bioremediation project where no continuous gas injection is maintained, the concentration gradient can be used to model the diffusive flux using the effective diffusivity of the soil layer as additional input. The extent of this diffusive flux can be compared with the regulatory requirements for maximal emission or maximal emission levels based on the assessment of human health and ecological risks.

When the advective soil air flux through the buffer zone and the effective diffusivity of this zone are known, the theoretical concentration gradient of the contaminants can be calculated assuming no biodegradation will occur. The difference between this theoretical model and the observed concentration gradient is caused by the biodegradation of the contaminant through the buffer zone. A biodegradation rate can then be determined.

Considering the advective and diffusive processes combined with the biodegradation rate and the measured concentration gradient near the top of the buffer zone or near the soil surface it becomes possible to calculate the actual flux that will be caused by a theoretical concentration gradient. Inversely, it is possible to determine the sharpest concentration gradient that is possible near the top of the buffer zone that will not cause an excessive emission.

As long as the monitored concentration gradient is less steep, there is a possibility to increase the bioremediation speed within the system. When increasing the bioremediation in the polluted zone, by controlling one or more of the parameters for this process as described below, higher fluxes of volatile contaminants might be passed into the buffer zone. The capacity of the buffer zone for additional bioremediation of these volatile contaminants can thus be maximally exploited while still providing proof that no excessive emissions occur.

When the observed concentration gradient approaches the sharpest concentration gradient not causing excessive emissions, the steering of the remediation process has to be controlled to provide a stable flux of contaminants towards the buffer zone.

In the case of (bio-)sparging or (bio-)venting with continuous injection of gas a proper control variable might be the mass flux of the injected gas. The mass flux of the gas injection can be regulated by means of increasing or decreasing the injection pressure by means of electronic valves or increased operation of compressors. An electronic pressure regulator will be steered by a control unit after interpretation of the concentration gradient sensors according to the invention and increase the injection pressure in case the remaining available remedial capacity in the buffer zone is not fully used. In the opposite case, when the risks of excessive emissions might occur based on the interpretation of the concentration gradient, the injection pressure can be lowered to reduce the rate of the remediation.

In the case of (bio-)sparging or (bio-)venting with intermittent injection of gas a proper control variable might be the duration of consequetive periods of injection and the ratio of the duration time of an injection over the time laps between injections. The average mass flux of the gas injection can be then regulated by means of electronically steered valves. An electronic valve is steered by a control unit after interpretation of the concentration gradient sensors according to the invention following an adapted injection schedule. Increasing the ratio of the duration time of an injection over the time laps between injections, will increase the remediation speed while reducing this ratio will lower the remediation speed and consequently the emission rates.

In the case of biopiles or landfarming the proper control variable is the average mass flux and or temperature. The average mass flux can be controlled by regulating the injection pressure of the gas electronically or by controlling the duration of the injection and the time lapse between injection periods. The temperature can be controlled by means of heating the injected gas or by controlling a separate heating system that is often foreseen in the biopile.

As indicated above, in some embodiments, the present invention may include use of a model for controlling the remediation. Some embodiments of the present invention are adapted for providing feed back and steering of the underlying remediation process based on the expected Volatile Organic Compounds (VOC's) concentration at the surface. The prediction of this VOC concentration requires the calculation of the parameters of a model using actual VOC concentration measurements in the soil. The selected model may be any suitable model, e.g. an existing model typically used for remediation. Advantageously an inverse model, deriving the concentration gradient as would be present based on the measurements, and a forward model, adapted for determining a predictive concentration gradient, may be used for predicting the remediation progress in future. Mathematical models are extensively used to help determining a successful set of operational parameters. As basis for the models the convection dispersion model was used describing the advective and diffusive gas flow through a porous medium. By way of illustration, embodiments of the present invention not being limited thereto, a one-dimensional convection dispersion model (Equation 1) was used in the examples below:

$$R \frac{\partial {c}_{r}}{\partial t} = D \frac{{\partial }^{2} {c}_{r}}{\partial {x}^{2}} - v \frac{\partial {c}_{r}}{\partial x} - μ {c}_{r} + γ ( x ) \qquad ( 1 )$$

Where R is the retardation factor describing the effect of the sorption and dissolution of the contaminant on the liquid and solid phase (−), cᵣ is the volume-averaged or resident concentration of the gas phase (kg·m⁻³), x is the distance (m), t is the time (s), D is the effective diffusivity coefficient (m²·s⁻¹), v is the average pore velocity of the gas (m·s⁻¹) μ is the first-order degradation coefficient for the combined air and liquid/solid phase (s⁻¹) and γ is the zero-order production term for the combined air and liquid/solid phase (kg⁻¹·s⁻¹)

Henry's law is accepted as guidance for the VOC partitioning between the gas and liquid phase. At equilibrium, the liquid phase solid phase partitioning of the contaminants is determined by a linear isotherm. When combining the repartitioning of the gaseous contaminant over the liquid and solid phase combined, the retardation factor is defined according to equation 2.

$$R = 1 + \frac{θ}{H ɛ} + \frac{{ρ}_{b} {K}_{d}}{H ɛ} \qquad ( 2 )$$

where R is the retardation factor (−), θ is the volumetric moisture content (−), H is the Henry coefficient (−C_{gas}/C_{water}), ρ_{b} is the bulk density of the soil (kg m⁻³), K_{d} is the partitioning coefficient liquid-solid (−), and c is the air filled porosity of the soil (−).

Often the repartitioning of the contaminant between the gas phase, the liquid phase and/or the solid phase is not instantaneous. It is also possible that a part of the gas phase does not participate in the advective flow. The equilibrium convection-dispersion model as described in equation 1 has to be expanded with equations describing the rate-limited transfer between phases or within phases. The first example presented, assumes an important effect of a restricted mobility of the gas in the gas phase leading to the definition of a first-order rate-limited diffusion of the gaseous contaminants between the mobile and immobile parts of the gas phase. The mass transfer between the gas and liquid/solid phase are then assumed to be instantaneous. The second example is also modeled using a non-equilibrium model. In this case the model is a one-site fully kinetic adsorption model which means the gas phase is fully mobile but the partitioning between the gas phase and the combined liquid/solid phase is considered to be rate limited. A first-order rate is assumed.

An initial estimate or measurement of the spatial concentration profile in a field situation will be used as initial conditions. As initial conditions for the presented examples the concentration in the column was set to 0 in both cases (Equation 3).

cᵣ(x,0)=Cᵢ(x)=0 (3)

Where cᵣ(x,0) is the concentration (kg·m⁻³) at position x and time 0 and Cᵢ(x) is the initial concentration (kg·m⁻³) at position x.

In both cases the inlet boundary conditions were provided as a third type boundary condition (Equation 4) under the form of multiple pulse inputs based on the observations of the first sensor. However, in case the source location and concentration is known less calculation intensive approximations of the boundary conditions can be formulated.

$${vc}_{r} ( 0 , t ) - D \frac{\partial {c}_{r} ( 0 , t )}{\partial x} = {vc}_{0} ( t ) \qquad ( 4 )$$

Where cᵣ(0,t) is the concentration (kg·m⁻³) at position 0 and time t and c₀(t) represents the concentration depending on time t.

The outlet condition is in both the examples approximated by assuming a semi-infinite system according to equation (5).

$$\frac{\partial {c}_{r}}{\partial x} ( ∞ , t ) = 0 \qquad ( 5 )$$

The proposed methodology offers a stricter control of the injection schemes for soil venting and air sparging. It is assumed, this will often permit a less energy intensive injection with slower air injection rates. Furthermore, the incompressibility of the soil gas phase is assumed. The used model may be selected based on the preliminary investigation of the site characteristics and the expected conditions imposed by the remediation technique.

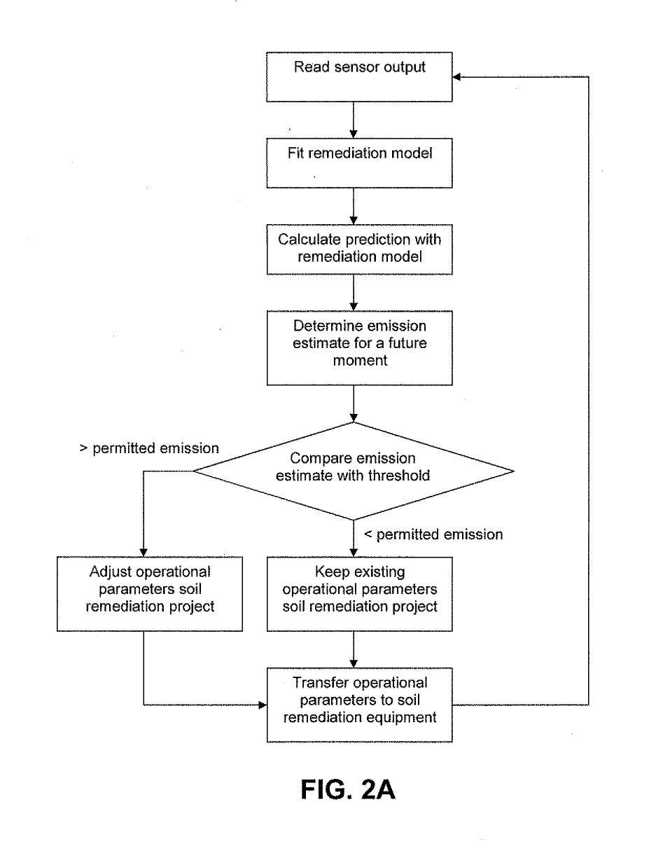

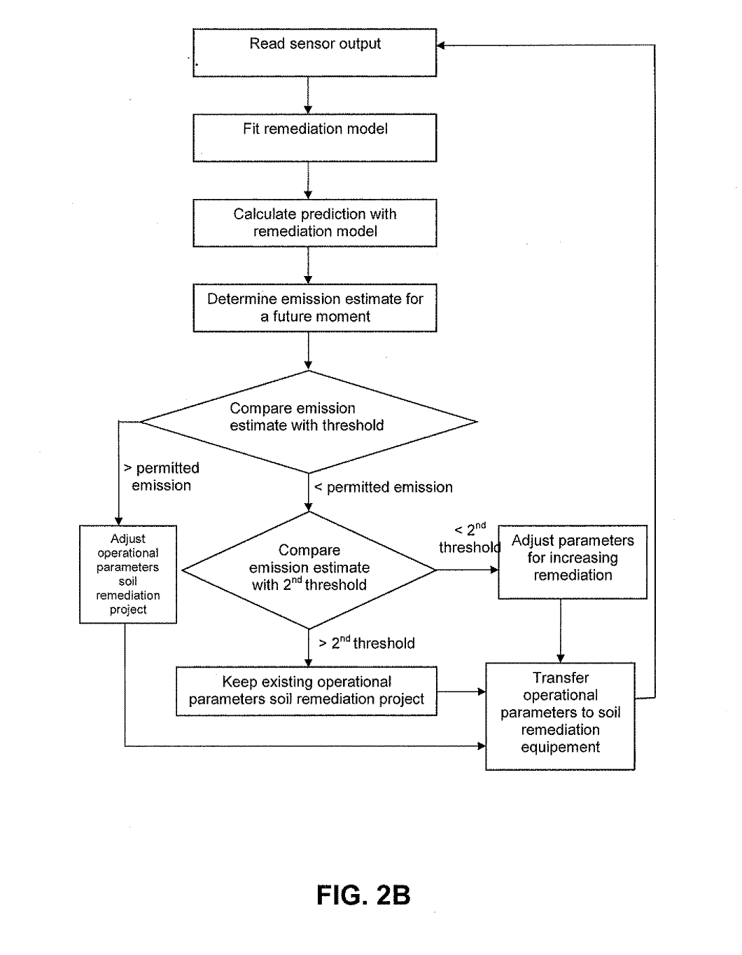

In FIG. 2 an example of a method as could be used according to an embodiment of the present invention is shown. The method comprises obtaining a sensor output, the sensor output advantageously comprising spatial information regarding the concentration. The obtained sensor output then is used for fitting an inverse remediation model to the sensor output. The model thereby may be any suitable model as described above. Based on the obtained info a direct model is used to determine an emission estimate for a future moment. In a decision step, the obtained emission estimate is compared with a threshold, e.g. a regulatory threshold subscribed as can be prescribed by a regulatory commission. If the estimated emission is larger than the allowed threshold, the operational parameters of the soil remediation are adjusted. Such adjustment may be based on predescribed rules, on a self learning process such as based on neural networks, on an algorithm, etc. If the threshold is not exceeded, the existing operational parameters of the soil remediation may be maintained. In an additional step a lower threshold can be checked. As long as this threshold is not reached, the remediation rate can be increased without risking excessive emissions. The operational parameters of the soil remediation are to be adjusted to increase the remediation speed. Again, such adjustment may be based on predescribed rules, on a self learning process such as based on neural networks, on an algorithm, etc. The latter is indicated by way of illustration in FIG. 2B, showing a similar process as in FIG. 2A, wherein one or more additional decision steps are present for evaluating whether a second, lower, threshold is reached and whether further increase of the remediation can be done. The system then provides the adjusted or maintained operational parameters to the soil remediation system. The above process may be performed continuously or at predetermined moments in time. The method as described above may be a computer implemented method. It may be performed in an automated and/or automatically manner. The method may be implemented on a controller, whereby the controller is adapted for receiving the input parameters, e.g. the sensor output, for controlling a microprocessor for performing the model calculations and for performing the evaluation step, and for controlling the remediation system.

The system can reach an accurate model capable of predicting the gaseous contaminant emissions towards the atmosphere faster when additional parameters can be included. The most important parameters can be given as fixed inputs or as initial estimates during an optimization procedure fitting the required parameters of the convection-diffusion equation. These parameters include the advective gas flow through the system, estimates of the relative effective diffusivity and estimates of the retardation coefficient which can be based on the nature and the composition of the contaminants and the organic matter content of the soil or might be directly measured in laboratory tests.

All crucial parameters involving the successful operation of a bioremediation process can be steered using the feedback from the method. This includes raising the temperature for better performance of microbiological degradation by preheating the injected gas to a higher temperature or heating up the buffer zone and/or polluted zone directly by increasing for example the power to an electroreclamation unit or by increasing the injection rate during steam injection. The injected composition of a composite nutrient can be altered by applying the valves separately for each of the chemical components separately. The amount of added nutrients can be increased by increasing the pump speed of the delivery system. Any carbon source added to stimulate co-metabolism can be injected as a gas regulating the gas pressure to adjust the amount or will be delivered in liquid form by injecting it. In that case, the pump speed of the delivery system can be adapted. Controlling the moisture level can be done by means of a surface or buried irrigation system in biopiles as well as in situ. In both cases the ratio on/off and the provided pump pressure can be used to regulate the moisture content. Together with the irrigation, surfactants can be injected to increase the bio-availability of the contaminants. The dosage of the biosurfactant can be regulated by adjusting the pump speed regulating the injection of the biosurfactant into the irrigation water. By way of illustration, embodiments of the present invention not being limited thereto, two particular experiments are discussed in detail below, illustrating some features and advantaged of embodiments according to the present invention. The examples illustrate for two remediation techniques that the critical point in future can be successfully predicted. In order to illustrate this possibility, the underlying remediation techniques in the examples are not altered, whereas this would be the case when applying the remediation techniques in practice.

Both experiments were based on performing remediation techniques in large soil column tests, designed for simulating a soil venting with soil vapour extraction for the first experiment and a bioventing solution for the second experiment.

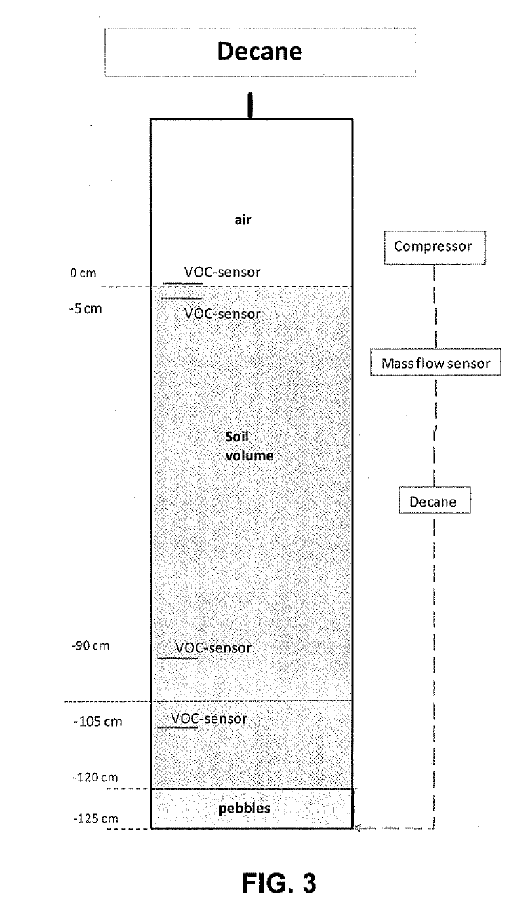

In the first particular example, the process of a soil venting in combination with a soil vapour extraction unit was simulated in the soil column test. The aim of the design is in this case to reduce the gas extraction rate when the extracted air will contain a gaseous contaminant level below a preset minimum. In this way soil vapour extraction can be minimized, resulting in a lower operational time and/or lower energy consumption of the soil vapour extraction or the off-gas treatment equipment of the soil vapour extraction and thus in a more cost efficient remediation. The analytical setup consisted of a stainless steel column with a diameter of 25 cm and a length of 150 cm. At the end of the tube two covers were placed to close of the columns, adding an additional 5 cm to the length of the column at each site. Gas could be injected in the column through a tube connected to the side of the bottom cover. The gas exited the system through an opening in the centre of the top cover. A schematic overview of the column design and the placing of the sensors during the soil venting test is presented in FIG. 3.

The bottom cover was filled with 5 cm of pebbles to ensure a virtually unrestricted distribution of the injected gas over the complete surface of the column. On top of the pebbles, a perforated metal sheet and a nylon cloth were placed to prevent soil material blocking the pore space between the pebbles.

A sandy material with a low organic carbon content (foc=0.0004) was placed on top of the nylon sheet. This repacked soil material with a bulk density of 1.25 10³ kg·cm⁻³ was inserted ensuring a homogeneous distribution. In a separate test the effective air-filled porosity and the effective relative diffusivity were determined for this repacked soil to provide validation of the methodology and to provide initial estimates. Alternatively, such parameter values also could be obtained in a different way. The main characteristics of the repacked soil are summarized in TABLE 1. To ensure a homogeneous bulk density throughout the soil column, the material was added in layers of 5 cm. After completion of the test, bulk density samples were taken to confirm the homogeneity of the soil.

While inserting the soil material passive sensors for volatile organic compounds (VOCs) were placed in the column. These sensors were placed at depths of 0, 5, 90 and 105 cm below the surface of the soil. The VOC-sensors were connected by means of UTP cables to a switch and PC for registering the data.

At the beginning of the test, compressed air was injected in the soil column after bubbling through a measuring cylinder filled with decane. The main parameters of the soil and solvent influencing the decane movement through the soil are given listed in TABLE 2. The decane enriched injection lasted for half an hour. The injected decane mass amounted to 0.210 10⁻³ kg as determined by the mass loss from the measuring cylinder during the initial period. After 30 minutes the measuring cylinder was removed and clean, air was passed over the column. The injection rate was monitored in intervals of 5 seconds during the complete injection period by means of a mass flux sensor connected to the bottom inlet of the column. Because the injected air flux was kept constant, an average injection rate can be assumed during the modeling of the results. The average injection rate of 71 cm³·minute⁻¹ (4260 10⁻³ m³·s⁻¹) caused a calculated soil pore velocity of 17.7 cm/s.

During the injection and subsequent flushing of the decane the VOC concentrations in the soil gas phase where recorded at intervals of 5 seconds at several depths in the soil. The passive VOC sensor used in this application has a broad sensitivity. A correction factor was used to convert the reading of the VOC-sensors to a concentration of decane similar in procedure as the conversion of the output of a photo ionization detector to a VOC concentration.

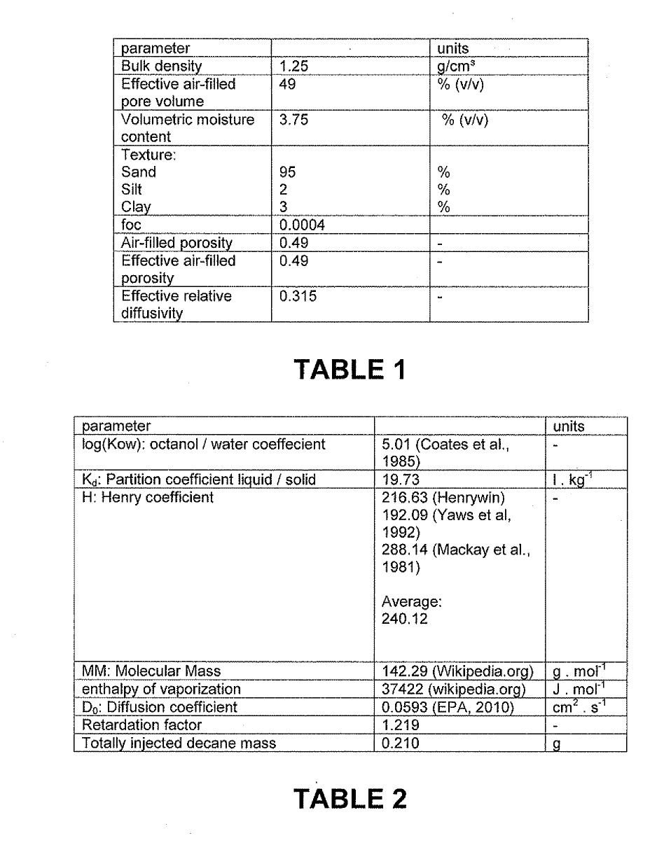

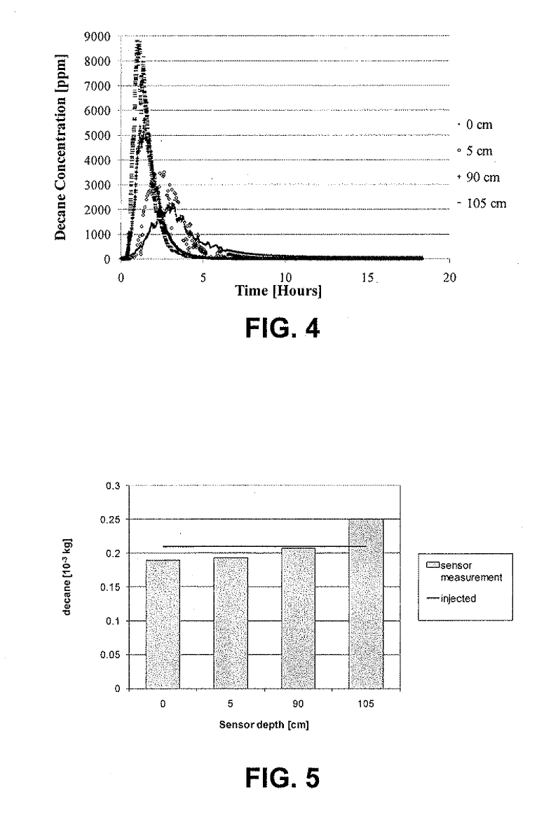

The measured VOC concentrations during the injection and subsequent depletion of the decane are presented in the form of breakthrough curves in FIG. 4 for the sensor at depths 0 cm, 5 cm, 90 cm, and 105 cm below the surface of the soil material in the column. After the initial injection of decane enriched air for 30 minutes, the soil was flushed with clean air for a further 18 hours.

At the end of the test the decane concentrations are equally low at all depths. Hence, all the injected decane has been evacuated from the soil column. Each of the sensors provides semi-continuous resident VOC concentration information of the soil gas phase. In combination with the stable averaged air injection rate, the total mass passing each sensor is calculated.

The mass balance for each of the sensors is depicted in FIG. 4 together with the injected decane. The calculated mass for each sensor corresponds strongly with the initially injected decane mass. A slight decline of the decane mass is expected during the transport through the column due to adsorption on the soil material, dissolution in the soil moisture and biodegradation. The decline is, however, marginal in this case because of the low organic carbon content and soil moisture content of the soil. The overestimate of the mass of the sensor at a depth of 105 cm is the result of a slight overestimation of the high concentrations that were recorded at this depth. The overall agreement with the expected value of 0.210 g decane proves the sensor data to be valid and the test equipment to be sufficiently airtight.

The concentration gradients that were measured are used as input data for an inverse modelling approach of the convection-dispersion model. During the progress of the column test collected data was gradually added to increase the accuracy of the inverse modelling. As soon as an acceptably high coefficient of determination (R²) has been reached, the model can be used to predict future concentrations.

Because of the high pore velocity (i.e. 17.7 cm/s) the local equilibrium assumption is not expected to be valid for the proposed soil column test. A 2 phase non-equilibrium model was chosen to represent a mobile gas phase in an immobile combination of liquid and solid phase. For the interactions between the liquid and solid phase instant equilibrium was assumed. Because of the low organic matter content of the soil material and the consequent low Kd value the errors introduced by this assumption are negligible.

In general, the boundary conditions of the inverse as well as the direct modelling consists of the VOC measurements of the sensor that is first encountered in function of the inflowing gas through the soil. To improve the predictive value of the direct model additional multiple step input values can be estimated. This is specifically important when the VOC concentration changes rapidly due to a passing peak of contaminants. As a first approximation a linear fit on the last VOC observations at the input location can be extrapolated. Peaks can be incorporated adequately as is shown further in the direct modelling approach of the soil venting.

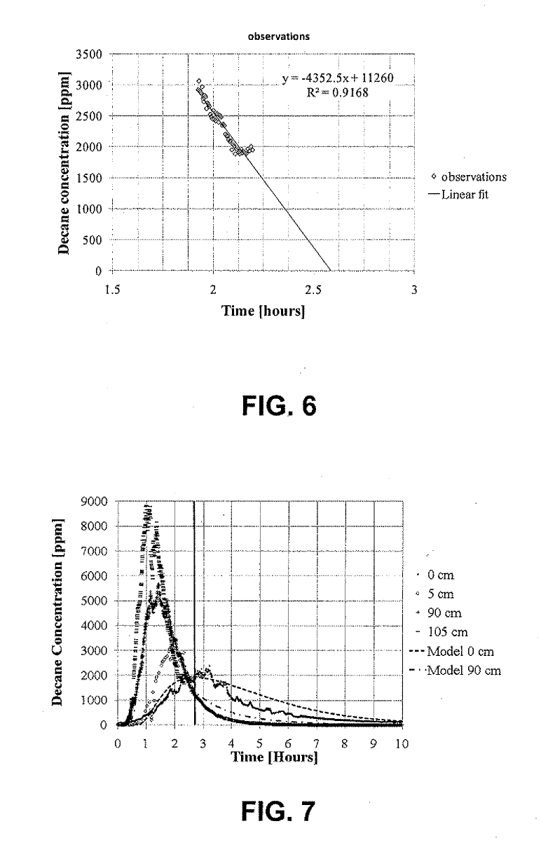

For the direct modeling 2.34 hours after the start of the column test, the linear extrapolation depicted in FIG. 6 is used to provide the necessary multiple step inputs. Based on the results from the inverse modelling using the data available up to 2.34 hours into the test, and including the extrapolated pulse a direct model is calculated. The results are depicted as lines in FIG. 7, gas-phase at depth 0, 5, 90 and 105 cm below the surface of a sandy soil column of 120 cm depth during venting with air initially enriched with decane. It illustrates the model estimates at depth of 0 cm and 90 cm below the surface compared to the evolution of the decane concentration measured at that depth. The vertical line in this figure indicates the point in time for which the model started predicting. Observation points before this line were included during the inverse modeling, while the observations in the graph after 2.34 hours are only included to show the successful fit of the model. The model clearly indicates that at the surface, the peak of the decane concentration has been reached. A further increase of the concentration is not expected. The model only shows a small overestimation of the expected concentration near the surface. The prediction for the first hour is accurate enough to allow for immediate adaptation of the operational parameters if necessary based on the emission levels that are permitted. The successful fit of the long term prediction of the model indicates that even a remediation process which responds slowly to changed operational parameters can be adjusted timely. In this particular case it can be concluded that the air injection should be slowed down at this moment to keep the decane concentration in the extracted air sufficiently high within two hours.

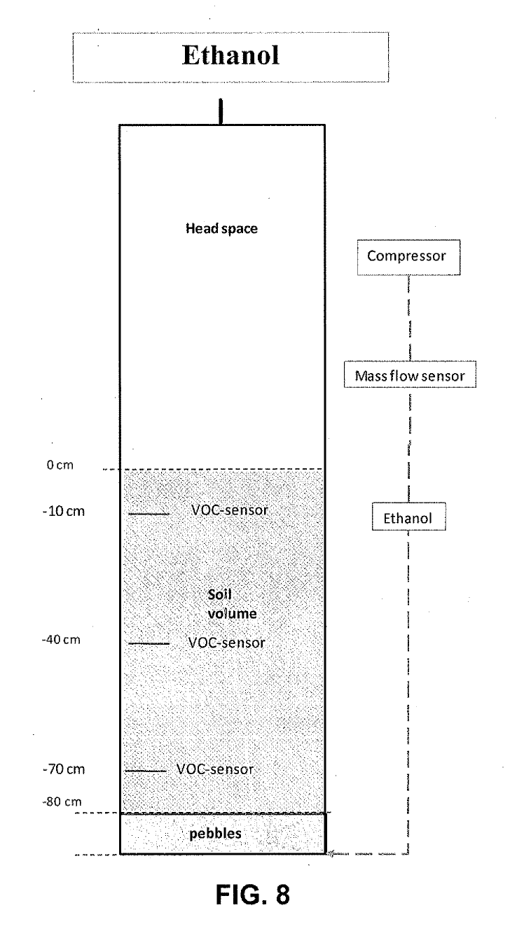

In a second experiment, bioventing based on biodegradation of contaminants was explored. The crucial factor limiting the operational costs is in this case the need for the off-gas treatment. The prevention of excessive emissions can reduce or cancel the need for this off-gas treatment and the SVE unit installed for the collection of the gaseous contaminants. The design of the test is indicated in FIG. 8, illustrating a schematic overview of the column design and the placing of the sensors during the bioventing test. Just as in the previous example a metal screen and a nylon sheet was placed on top op a 5 cm thick layer of pebbles. Next, a homogeneous soil layer of 80 cm thickness was placed on top of the mesh. VOC sensors were installed at 10, 40 and 70 cm below the surface of the soil material. A summary of the parameters of the homogeneous soil material is presented in TABLE 3.

A continuous flow of ethanol enriched air was established over the soil column. The parameters of the flow and the solvent are given in TABLE 4.

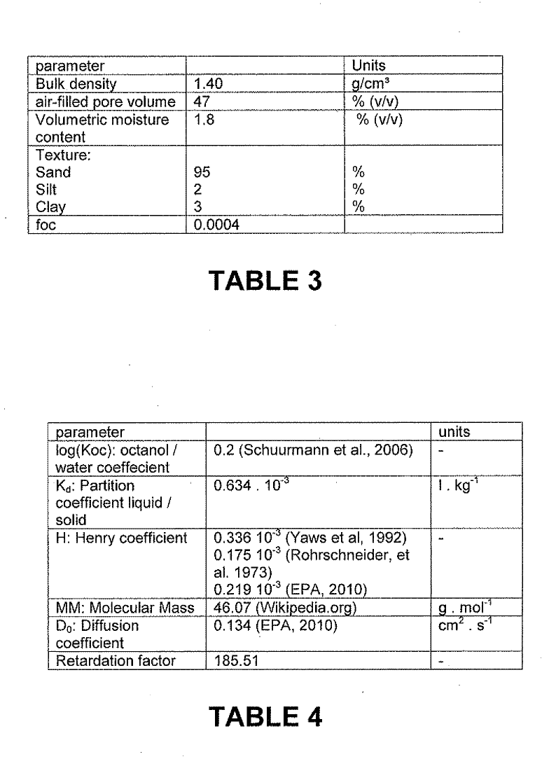

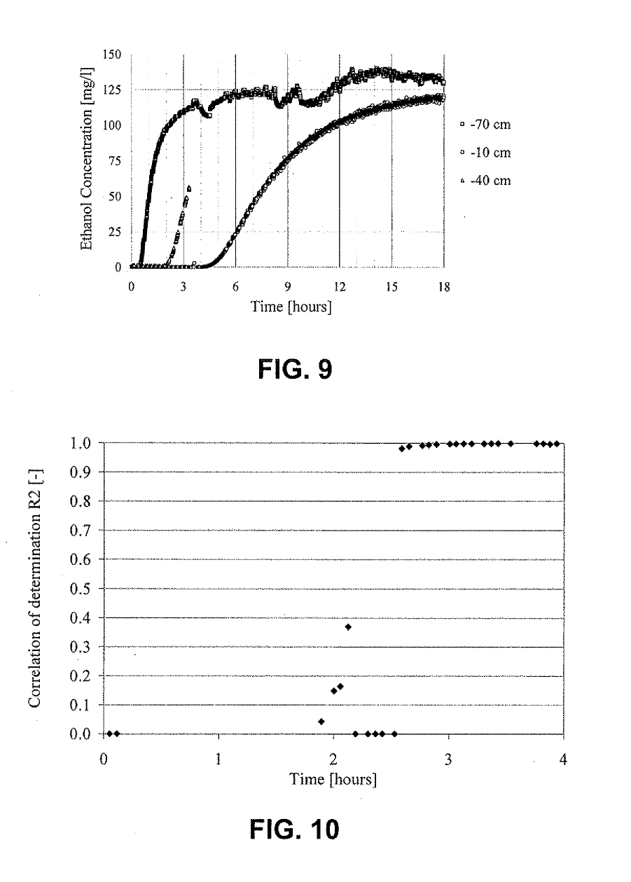

The breakthrough curves were measured at depths of 10, and 70 cm below the soil surface (depicted in FIG. 9). FIG. 9 more particularly illustrates the evolution of the ethanol concentration in the gas-phase at a depth of 10 cm, 40 cm and 70 cm below the surface of the sandy soil column of 80 cm depth during venting with ethanol enriched air. A partial breakthrough curve is available at a depth halfway the soil column. During this soil venting, the advective flow is much lower than in the previous test which focussed on the simulation of a soil vapour extraction. It is crucial in this case to have an early warning of a threshold being exceeded at the surface so the remediation process can be adapted timely to avoid the emission.

A non-equilibrium advection dispersion model was used to conduct the inverse modeling. Chemical non-equilibrium as a result of kinetic adsorption was expected. This means that the adsorption on at least a part of the adsorption sites is not instantaneous. For this particular case first-order kinetics were assumed. Because of the low pore space velocity, there is no need to split up the soil gas phase in a mobile and immobile fraction. The applied advection dispersion model is the one-site fully kinetic adsorption model. The first order kinetics are described with the first order kinetic rate coefficient α [s⁻¹]. The sensor readings of the deepest VOC-sensor where used as multiple pulse inputs boundary conditions during the inverse modelling. This allows the method to be applied for complex and/or incompletely known pollution zones.

After the start of the test, observations of the VOC were gradually collected. This means that an increasing dataset was available for the inverse modelling. This means that over time, the estimates of the parameters necessary for the model will be determined with increasing accuracy. The coefficient of determination (R²) between the observed data and the modeled data can be used to detect an acceptable fit. In FIG. 10 the evolution of the coefficient of determination (R²) for the inverse modeling is represented in function of time. Although an acceptable value for this parameter is reached after 2.6 hours, at least one of the corresponding values for V, D, R and α is giving unrealistic values until the dataset is expanded to include all the data until 3.76 hours. At that moment, the inverse modeling was successfully completed and the direct model could be used to predict the evolution of the ethanol concentration in the future. Obviously, further fine tuning of the model remains possible and even desirable when new data becomes available.

Similar as for the inverse modeling, the direct model uses the sensor readings of the deepest VOC-sensor as multiple step boundary condition. In the previous example a peak passing through the column had to be detected. In this example there is no peak, and the gradual increase of the concentration leads to the conclusion that the best estimate for multiple step inputs in the future will be the last available measurement.

However, later in the bioventing remediation process when the peak starts declining due to exhaustion of the contaminants or due to a correction of the operational parameters caused by the system, an extrapolation of a linear fit might provide a better estimate for future multiple step inputs.

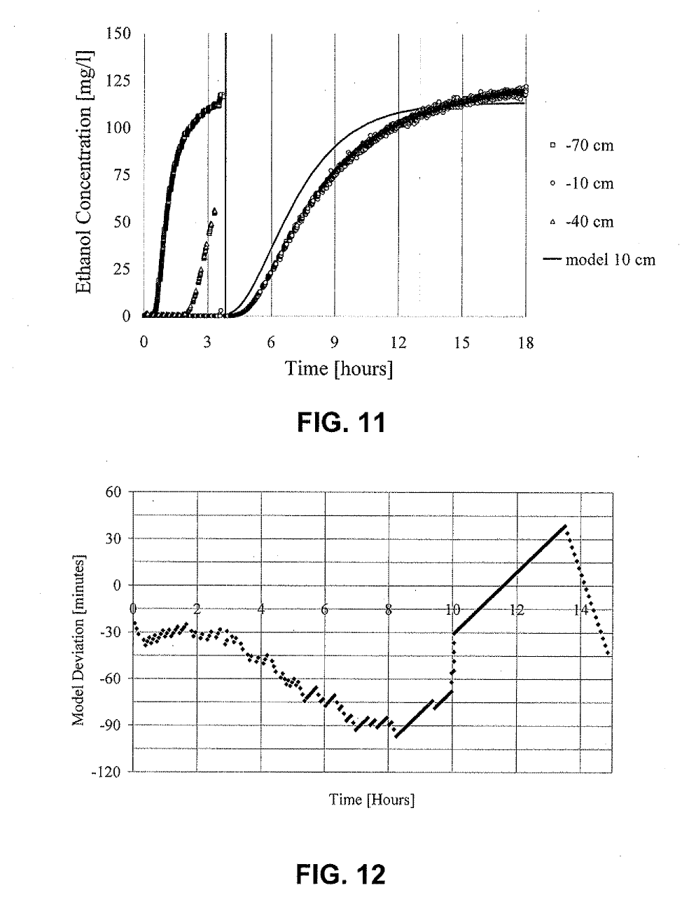

FIG. 11 shows that the model developed after 3.76 hours provides a good fit that will predict the evolution of the ethanol good for the following 14 to 15 hours. The final concentration that is being observed when the ethanol concentration levels out near the surface is slightly underestimated. This is due to the assumption that the last observed concentration at a depth of 70 cm below the surface is taken as maximum concentration. It is obvious that when more observations become available the final concentration will be predicted more accurately as well.

The error in timing between the model and the observed values were calculated. To do so, the difference in time was recorded between the time when the model has reached a certain ethanol concentration as compared to the time when this concentration was actually measured. These calculations are depicted in function of the prediction time of the model in FIG. 12. The deviation in time between the model and the observed data to reach a similar concentration at a depth of 10 cm below the surface is shown versus the prediction time. A negative deviation in time means that the model has predicted the concentration that was measured at that specific time earlier and vice versa. This means that almost for 11 hours, the model has predicted the concentration slightly too early with a maximum deviation of 97 minutes too early for the predicted concentration after 8.26 hours. Considering that the method is designed to limit the risks of VOC emissions, it can be concluded that this model is a conservative estimate. After 11 hours, the observed values are higher than the estimates. As mentioned before, this is a result of using the last observed value as a boundary condition for the complete pulse. In case the predictive model has to remain a conservative estimate for more than 11 hours, the multiple pulse approach of the previous example should be used. An estimate of the ethanol concentration at the peak value by means of an extrapolation of a linear fit will provide a higher predicted ethanol concentration after 11 hours.

The convection dispersion model that is being used in the provided examples shows in equation 1 that both temporal and spatial concentration gradients can be used. Thus, when using any form of a convection dispersion model, the available concentration gradients are derived from the measured data developing for example a good fit for the parameters based on the concentration gradients between adjacent cells and/or consecutive time steps. In more general terms, including the possibility to use a different model than the convection-dispersion model, the concentration gradient in time will be similar to a breakthrough curve or a part thereof while the concentration gradient in spatial terms will be similar to a spatial concentration profile or a part thereof.

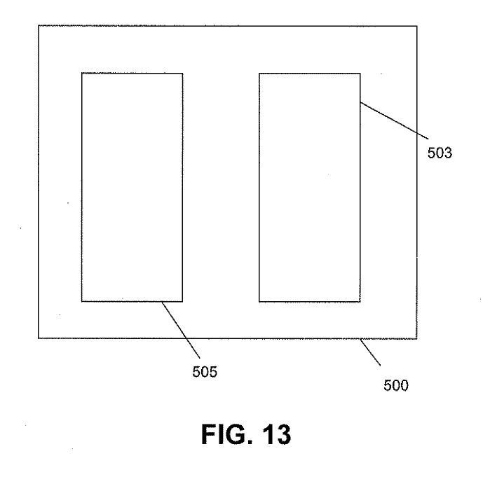

The above described method embodiments for controlling remediation may be at least partly implemented in a processing system 500 such as shown in FIG. 13. FIG. 13 shows one configuration of a processing system 500 that includes at least one programmable processor 503 coupled to a memory subsystem 505 that includes at least one form of memory, e.g., RAM, ROM, and so forth. It is to be noted that the processor 503 or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. For example, the remediation model calculations may be a computer implemented step. Thus, while a processing system 500 such as shown in FIG. 13 is prior art, a system that includes the instructions to implement aspects of the methods for controlling remediation is not prior art, and therefore FIG. 13 is not labelled as prior art.

The present invention also includes a computer program product which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practising the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1-26. (canceled)

27. A method for controlling a remediation of a material or site polluted by contaminants, the method comprising the steps of
obtaining at a plurality of spatially distinct positions a measured indication of a level of the contaminants in the atmosphere above the material or ground of the site and/or in the material and/or in the soil air of the site, wherein the measured indications of a level of the contaminants are indications of gaseous contaminants measured by a plurality of gas sensors which are offset in a vertical extent in a buffer zone overlying the polluted material or site,
calculating a concentration gradient of gaseous contaminants exhausting from the polluted material or site based on a remediation model using said plurality of measured indications measured at a plurality of spatially distinct positions,
and controlling a remediation technique taking into account the concentration gradient of the gaseous contaminants exhausting from the polluted material or site.

28. A method according to claim 27, wherein the step of controlling the remediation technique comprises determining a future concentration gradient of the gaseous contaminants using a predictive remediation model, comparing the determined future concentration gradient with the calculated concentration gradient and deciding based thereon if the remediation technique is to be adapted.

29. A method according to claim 27, wherein the step of controlling the remediation technique comprises the step of checking that the gaseous contaminants do not exceed a predefined level.

30. A method according to claim 28, wherein the step of controlling the remediation technique comprises, based on the determined future concentration gradient, the step of increasing remediation without exceeding a predefined level.

31. A method according to claim 28, wherein the remediation technique comprises extraction of the gaseous contaminants using a soil vapour extraction and off-gas treatment system, wherein the soil vapour extraction and/or off-gas treatment is controlled taking into account the determined future concentration gradient.

32. A method according to claim 28, wherein the predictive remediation model is adapted for determining the maximum degradation of the polluted site without exceeding the remediation capacity of at least the buffer zone.

33. A method according to claim 28, wherein the predictive remediation model is adapted for determining a maximum degradation of the polluted material or site without exceeding a remediation capacity of a polluted zone and the buffer zone overlying the polluted material or site combined.

34. A method according to claim 27, wherein the step of controlling the remediation technique comprises using a self-learning optimisation model.

35. A method according to claim 27, wherein the remediation technique comprises a treatment in situ and/or ex situ.

36. A method according to claim 27, wherein the concentration gradient is a spatial concentration gradient.

37. A method according to claim 27, wherein the measured indication of a level of the contaminants is any of the concentration or chemical activity of the contaminants.

38. A system for controlling a remediation of a material or site polluted by contaminants, the system comprising:
a control unit for calculating a concentration gradient of gaseous contaminants exhausting from the polluted material or site towards the atmosphere based on a remediation model using obtained measured indications of a level of the contaminants obtained at a plurality of spatially distinct positions in the atmosphere above the material or ground of the site, wherein the measured indications of a level of the contaminants are indications of gaseous contaminants measured by a plurality of gas sensors which are offset in a vertical extent in a buffer zone overlying the polluted material or site, and for controlling a remediation technique taking into account the calculated concentration gradient of the gaseous contaminants exhausting from the polluted material or site.

39. A system according to claim 38, wherein the control unit is arranged to determine a future concentration gradient using a predictive remediation model, for comparing the determined future concentration gradient with the calculated concentration gradient and for deciding based thereon if the remediation technique is to be adapted.

40. A system according to claim 38, the control unit further being arranged to measure an indication of the level of contaminants in a buffer zone overlying the polluted material or site.

41. A system according to claim 38, wherein the control unit comprises a plurality of gas sensors installed in a vertical extent in a buffer zone overlying the polluted material or site for measuring or calculating an indication of the level of contaminants.

42. A system according to claim 38, wherein the control unit is arranged to control the remediation technique towards achieving a maximum degradation of the polluted material or site being defined without exceeding a remediation capacity of the buffer zone.

43. A system according to claim 38, further comprising a polluted zone producing gaseous contaminants and a polluted soil medium transferring the gaseous emissions towards the buffer zone overlying the polluted material or site, wherein the polluted soil medium is provided on top of the polluted zone.

44. A system according to claim 43, wherein the buffer zone comprises a degradation rate which is sufficient for remediation of the gaseous contaminants emitted from the polluted zone towards the buffer zone and those originating from the buffer zone.

45. A system according to claim 43, wherein the polluted site is provided as a biopile, and wherein the buffer zone is provided as a reactive barrier capable of absorbing and/or degrading the gaseous emissions of the biopile.

46. A computer program product for, when executed on a computer, performing a method for controlling a remediation of a material or site polluted by contaminants, the method comprising the steps of
obtaining at a plurality of spatially distinct positions a measured indication of a level of the contaminants in the atmosphere above the material or ground of the site and/or in the material and/or in the soil air of the site, wherein the measured indications of a level of the contaminants are indications of gaseous contaminants measured by a plurality of gas sensors which are offset in a vertical extent in a buffer zone overlying the polluted material or site,
calculating a concentration gradient of gaseous contaminants exhausting from the polluted material or site based on a remediation model using said plurality of measured indications measured at a plurality of spatially distinct positions,
and controlling a remediation technique taking into account the concentration gradient of the gaseous contaminants exhausting from the polluted material or site.
